(19) United States
(12) Patent Application Publication
(10) Pub. No.: US 2025/0390962 A1
(43) Pub. Date: Dec. 25, 2025

(54) Method for an Improved Information Storage and Retrieval System

(71) Applicant: Charles Landreville, Chelsea (CA)

(72) Inventor: Charles Landreville, Chelsea (CA)

(21) Appl. No.: 19/311,844

(22) Filed: Aug. 27, 2025

Related U.S. Application Data
(63) Continuation of application No. 18/536,882, filed on Dec. 12, 2023.

(51) Int. Cl. G06Q 40/12; G06F 16/23

(52) U.S. Cl. CPC G06Q 40/123; G06F 16/2379

(57) ABSTRACT

A system and method for storing and retrieving information when entering information from a variety of sources into a data table. The overall system includes a corresponding non-transitory computer storage media having instructions stored thereon which, when executed by a processor, performs the overall method steps. The overall method steps include creditor information that comes from a non-computer peripheral such as a credit card reading machine to read credit card information from a magnetic strip or a computer chip such as a Near Field Communication chip or NFC chip from credit cards that make-up the creditor information. The overall method also includes a digital cash register that utilizes a digital scanner to create a second table with creditors and purchasers.

### CROSS-REFERENCE TO RELATED APPLICATIONS

This Continuation-In-Part application claims the benefit of U.S. Non-Provisional application Ser. No. 16/425,236, filed May 29, 2019 and U.S. Non-Provisional application Ser. No. 18/536,882, filed Dec. 12, 2023. The above identified patent application is herein incorporated by reference in its entirety to provide continuity of disclosure.

### BACKGROUND OF THE INVENTION

The present invention relates to a system and method for storing information. More specifically, the present invention provides a system and method for storing and retrieving information when entering a plurality of information from a plurality of sources into a data table.

Computers have become a staple in everyday life over the last few decades. There is still a constant need to update the computing processes. These updates may add to the physical machines or logic that makes them function. In some respects, relatively larger and faster memories may be created. In others, new machine code is needed to improve the functionality of a computer. Many times, new ways to store and retrieve information may go a long way to improving computer functionality. These fast response times have become an expected feature by most users. Engineers are constantly creating improvements to computers and the processes which run them.

Consequently, there is always a need for an improvement in the art of data storage and retrieval. The present invention substantially diverges in design elements from the known art while at the same time solves a problem many people face in data storage and retrieval. In this regard, the present invention substantially fulfills these needs.

### SUMMARY OF THE INVENTION

The present invention relates to a system and method for storing and retrieving information. More specifically, the present invention provides a system and method for storing and retrieving information when entering a plurality of information from a plurality of sources into a data table.

The present system for storing and retrieving information comprises a server system with a processor system, a communications interface, a communications system, an input system and an output system, the server system having access to a communications network, a memory system with an operating system, a communications module, a web browser module, a web server application, and a non-transitory storage media for storing and retrieving information, the memory system is in communication with the server system through the communications network.

The present overall system includes a corresponding method for storing and retrieving information that includes the steps of entering a first set of information into a first table, learning a plurality of various associations based on the first set of information based on one or more purchases and one or more creditors, populating a second table with a plurality of records of the various associations, entering a partial set of second information, where the partial set of second information is a credit card statement, and completing the second set of information using records of the various associations in the second table.

The overall system includes a corresponding non-transitory computer storage media having instructions stored thereon which, when executed by a processor, perform the overall method for storing and retrieving information that includes the steps of entering a first set of information into a first table, learning a plurality of associations based on the first set of information based on one or more purchases and one or more creditors, populating a second table with a plurality of records of the various associations, entering a partial set of second information, where the partial set of second information is a credit card statement, and completing the second set of information using records of the various associations in the second table.

It's an object of the present invention to provide a system and method for storing and retrieving information that includes a credit card reading machine that reads a plurality of credit card information from a magnetic strip or a computer chip from a plurality of credit cards to create the first set of information and the partial set of second information.

It's an object of the present invention to provide a system and method for storing and retrieving information that includes a digital cash register that utilizes a digital scanner to create a second table with a plurality of creditors and a plurality of purchasers.

It's an object of the present invention to provide a system and method for storing and retrieving information that reads a plurality of credit card information from a magnetic strip, a computer chip such as a Near Field Communication or NFC or the like from a plurality of credit cards that make-up the data on the credit card statement.

It's an object of the present invention to provide a system and method for storing and retrieving information that locates one or more associations.

It's an object of the present invention to provide a system and method for storing and retrieving information that determines a tax rate associated with an area.

Other objects, features and advantages of the present invention will become apparent from the following detailed description taken in conjunction with the accompanying drawings

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of one embodiment of a system for storing and retrieving information.

FIG. 2A shows a block diagram of a client system of a system for storing and retrieving information.

FIG. 2B illustrates a block diagram of a server system of a system for storing and retrieving information.

FIG. 3 shows a flow chart of an embodiment of an overall method for storing and retrieving information.

FIG. 4 shows a flow chart of an embodiment of a method for storing and retrieving information that locates or forms one or more associations.

FIG. 5 shows a flow chart of an embodiment of a method for storing and retrieving information that calculates taxes.

### DETAILED DESCRIPTION OF THE INVENTION

Reference is made herein to the attached drawings. Like reference numerals are used throughout the drawings to depict like or similar elements of the data storage and retrieval system. For the purposes of presenting a brief and clear description of the present invention, the preferred embodiment will be discussed as used for the data storage and retrieval system. The figures are intended for representative purposes only and should not be considered to be limiting in any respect.

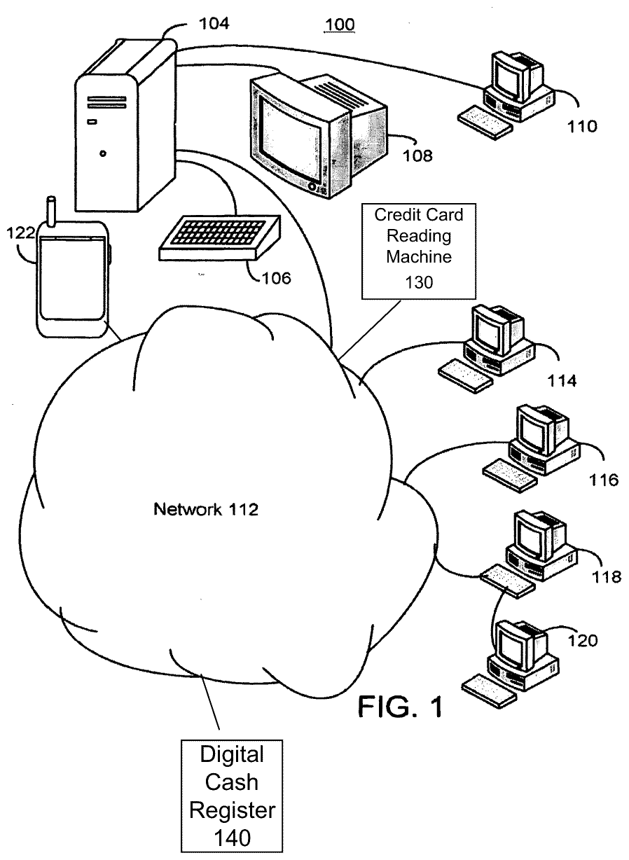

FIG. 1 shows a system overview of one embodiment of a storing and retrieving information system 100.

The storing and retrieving information system 100 may include a server system 104, an input system 106, an output system 108, a plurality of client systems 110, 114, 116, 118 and 120, a communications network 112, a hand-held device 122, a credit card reading machine 130, and a digital cash register 140. In other embodiments, the storing and retrieving information system 100 may include additional components and/or may not include all of the components listed above.

The server system 104 may include one or more servers. The server system 104 may be the property of the distributor of any related software or non-transitory storage media. In other embodiments, the storing and retrieving information system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The storing and retrieving information system 100 illustrates some of the variations of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

The credit card reading machine 130 may read a plurality of credit card information from a plurality of credit cards that make-up a plurality of creditor information.

The digital cash register 140 may utilize a digital scanner 142 to create a second table with a plurality of creditors and a plurality of purchasers.

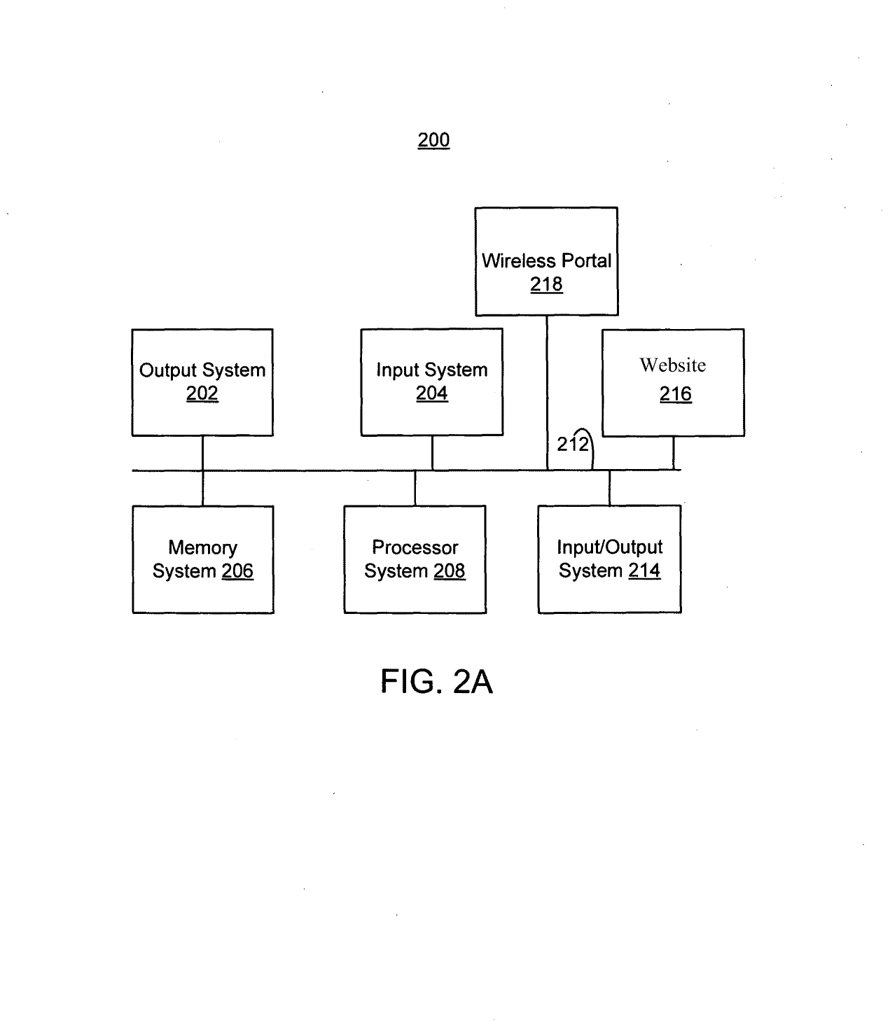

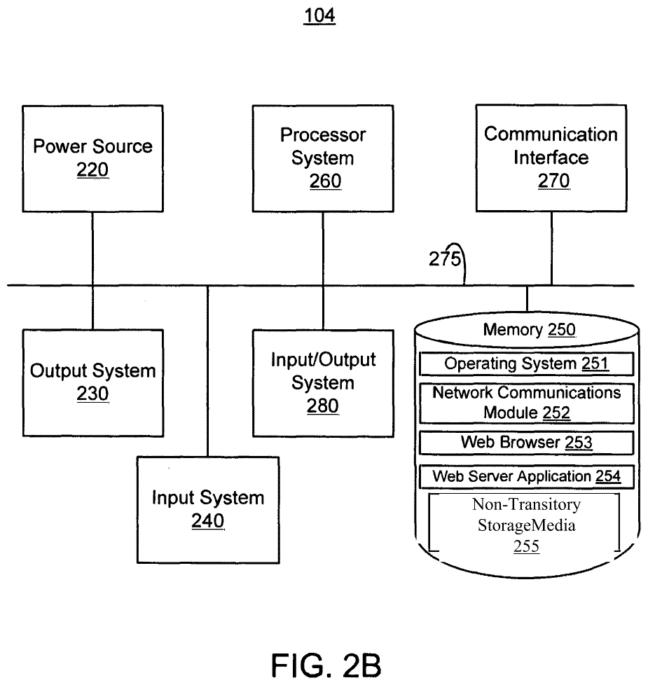

FIG. 2A shows a block diagram of a client system 200 of the storing and retrieving information system 100.

The client system 200 may include an output system 202, an input system 204, a memory system 206, a processor system 208, a communications system 212, an input/output system 214, a website 216, and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above.

The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example.

The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a non-transitory storage media for storing and retrieving information (FIG. 2B, 255).

The processor system 208 may include any one of, some of, any combination of, or all of multiple parallel processors, a single processor, a system of processors having one or more central processors and/or one or more specialized processors dedicated to specific tasks. The processor system 208 implements the non-transitory storage media for storing and retrieving information 255 stored on the memory system 206.

The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include a non-transitory storage media for storing and retrieving information 255 and a website module (no number) to maintain, allow access to and run the website as well.

FIG. 2B illustrates a block diagram of a server system 104 of a storing and retrieving information system 100.

The server system 104 may include a power source 220, an output system 230, an input system 240, a memory system 250, which may store an operating system 251, a communications module 252, a web browser module 253, a web server application 254, and a non-transitory storage media for storing and retrieving information 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store one or more machine instructions for storing and retrieving information.

The operating system 251 controls all software or non-transitory storage media and hardware of the storing and retrieving information system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the communications network 112. In this embodiment, the output system 230 sends communications to the communication interface 270. The communications system 275 communicatively buttons the output system 230, the input system 240, the memory system 250, the processor system 260 and/or the input/output system 280 to each other.

The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

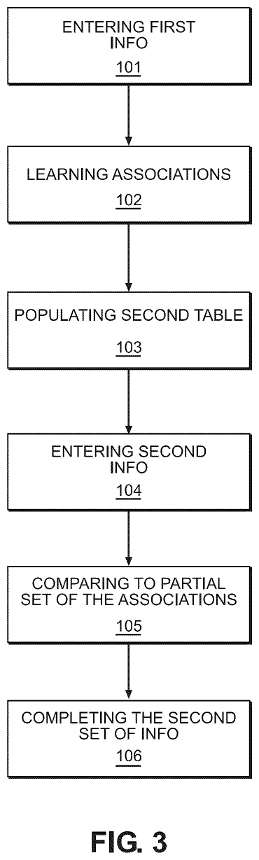

FIG. 3 shows a flow chart of an embodiment of an overall method for storing and retrieving information 200.

The overall method 200 may begin by entering a first set of data 201. In one embodiment, the data is a credit card statement or the like. The first set of data 201 from the credit card statements may come from a non-computer peripheral such as a credit card reading machine to read credit card information from a magnetic strip, a computer chip such as a Near Field Communication or NFC or the like from a plurality of credit cards that make-up the data on the credit card statement. Associations are then learned. The associations are learned 202 using either a reference number or a series of key words. In one embodiment, a type of good purchase will be linked to a specific reference number. The type of good purchased may come from a digital cash register that may utilize a digital scanner to obtain the type of goods purchased information. In another embodiment, key words will be used to learn associations between goods and merchants. The associations are then populated in a second table 203. In one embodiment, the associations are creditors and purchases made. The associations made from creditors and purchases made may come from a digital cash register that may utilize a digital scanner to obtain the associations. The associations are formed by assigning each association with key words and a reference number.

Next a second set of data is entered 204. This second set of data may be a partial set of data. In one embodiment, the second set of data will not have any creditor information. The creditor information may come from a non-computer peripheral such as a credit card reading machine to read credit card information from a magnetic strip, a computer chip such as a Near Field Communication or NFC or the like from a plurality of credit cards that make-up the creditor information. The method will take the second set of data and compare it to the associations 205 in the second table. The second set of data will be completed 206 using the associations. If no association may be found a new association will be learned.

In one exemplary use of the embodiment for storing a credit card statement, a user inputs a date of purchase, a creditors name, the creditors address, and the amount of the purchase. The table will then populate with the correct reference numbers from the associations table in the chart. When future statements are put in the chart, if a creditor is not found, a user may input a new creditor by providing the information above. The new creditor will then be assigned a reference number and key words.

In a large-scale embodiment of the credit card statement, or in an embodiment with a large number of creditors and associations learned when a charge is entered with no creditor, the non-transitory storage media may search for an association. This search may be done using word association. Each creditor will be given a list of key words or products. When a purchase is recorded from a digital cash register or the like with no creditor the method searches for a key word. When a key word is found the association is then suggested. A user may then accept this new association or learn one of their own.

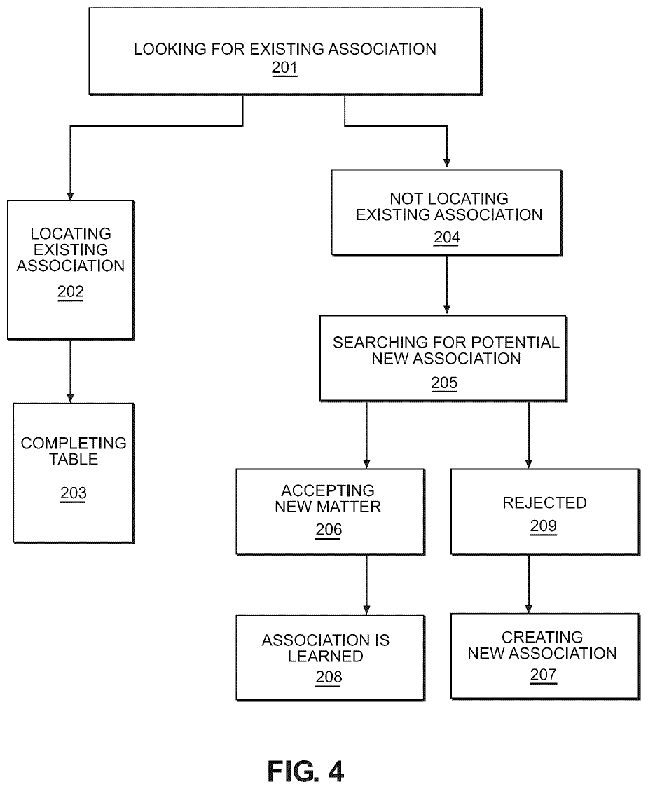

FIG. 4 shows a flow chart of an embodiment of a method for storing and retrieving information 300 that locates or forms one or more associations.

When data is entered, the non-transitory storage media looks to find an association 301 to complete the data. In a first embodiment, the data is entered and the non-transitory storage media searches the second table for an association. An association is located 302 based on the reference number. The data table is completed 303 with the association.

In a second embodiment, data is entered and the non-transitory storage media looks for an association 301. In this embodiment, the non-transitory storage media is unable to locate an association 304 using the reference numbers. The non-transitory storage media then looks to form a new association 305. The non-transitory storage media will search existing associations for key words. A new potential association will be suggested. This suggestion will be made using key words. In one embodiment, the key words will relate the goods purchases to the creditor. The new association may then be accepted 306 or rejected 309. If the association is accepted 306, the association will be learned 307. If the association is rejected, a new association may be manually created.

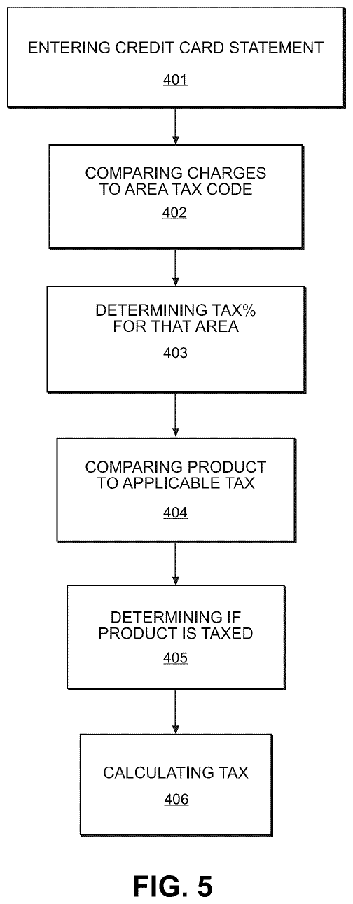

FIG. 5 shows a flow chart of an embodiment of part of the method that calculates taxes 500.

In various embodiments, the data to be entered is a billing statement or a purchase history or other type of financial statement. In this embodiment, the non-transitory storage media may further complete data by suggesting taxes and tax returns. Once the data has been entered 401 and populated a second method may run. This method starts by comparing charges to the area they were made in 402. The method then determines the tax rate or percent for that area 403. There is a third table that is populated with applicable tax rebates 404. The method, uses the third table to determine if the purchase is tax exempt 405 using a look up table. The method will then calculate the tax 406.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A non-transitory computer storage media having instructions stored thereon which, when executed by a processor, comprising steps of:
entering a first set of information into a first table;
learning a plurality of various associations based on the first set of information based on a plurality of purchases and a plurality of creditors;
populating a second table with a plurality of records of the various associations;
entering a partial set of second information;
completing the second set of information using the records of the various associations in the second table; and
comparing the partial set of second information to records of the various associations in the second table;
wherein a credit card reading machine reads a plurality of credit card information from a magnetic strip or a computer chip from a plurality of credit cards to create the first set of information and the partial set of second information;
wherein a digital cash register utilizes a digital scanner to create a second table with a plurality of creditors and a plurality of purchasers;
wherein the partial set of second information is a credit card statement;
wherein the series of keywords is utilized to learn associations between a set of goods and a set of merchants when the non-transitory storage media for storing and retrieving information is unable to locate one of the associations using the reference number and the non-transitory storage media for storing and retrieving information associates the series of keywords to a plurality of goods purchased to the creditors;
wherein the series of key words relate a plurality of goods purchases to the creditor and a new learning association is accepted or rejected; and
comparing charges made to purchases with the credit card in a specific geographic area and determining whether the purchases are tax exempt or not using data entered in the first and second look up table according to the learned association and the new association created by the program.

2. The non-transitory computer storage media, according to claim 1, wherein the various associations are learned using data selected by the non-transitory storage media for storing and retrieving information from a reference number, a series of keywords, or a combination thereof.

3. The non-transitory computer storage media, according to claim 1, wherein the new learning association is accepted and the new learning association is learned, storing the plurality of associations on the non-transitory computer-readable medium.

4. The non-transitory computer storage media, according to claim 1, wherein the first set of information includes a price spent on purchases from a creditor.

5. The non-transitory computer storage media, according to claim 1, further comprising the non-transitory storage media for storing and retrieving information generates a tax return statement based on the first set of information.

6. The non-transitory computer storage media, according to claim 1, further comprising assigning an area to each transaction.

7. The non-transitory computer storage media, according to claim 6, further comprising determining a tax rate associated with the area.

8. The non-transitory computer storage media, according to claim 7, further comprising the step of populating a third table with a set of applicable tax rebates.

9. The non-transitory computer storage media, according to claim 7, further comprising the step of populating a third table with a set of applicable tax rebates.
